(19) United States
(12) Patent Application Publication
(10) Pub. No.: US 2004/0076199 A1
(43) Pub. Date: Apr. 22, 2004

(54) Chirp control of integrated laser-modulators having multiple sections

(75) Inventors: Torsten Wipiejewski, Kowloon (HK); Larry A. Coldren, Santa Barbara, CA (US); David D. Lewis, Oxnard, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Agility Communications, Inc.

(21) Appl. No.: 10/646,288

(22) Filed: Aug. 22, 2003

Related U.S. Application Data
(60) Provisional application No. 60/405,233, filed on Aug. 22, 2002.

(51) Int. Cl. H01S 3/10

(52) U.S. Cl. 372/26

(57) ABSTRACT

A compensating electrical signal is applied to one or more sections of a laser to over-compensate for chirp from an external modulator employed for intensity modulation. The chirp of the laser is adjustable by design or electrical control.

### CROSS-REFERENCE TO RELATED APPLICATIONS

This application claims the benefit under 35 U.S.C. §119(e) of co-pending and commonly-assigned U.S. provisional patent application Serial No. 60/405,233, filed Aug. 22, 2002, by Torsten Wipiejewski, Larry A. Coldren and David D. Lewis, and entitled “CHIRP CONTROL OF INTEGRATED LASER-MODULATORS HAVING MULTIPLE SECTIONS,” which application is incorporated by reference herein.

### BACKGROUND OF THE INVENTION

1. Field of the Invention

This invention relates to microelectronic and optoelectronic components, and more particularly, to chirp control by electrical feedback.

2. Description of the Related Art

(Note: This application incorporates a number of different references as indicated throughout the specification by numbers enclosed in brackets, e.g., [x]. A list of these different references ordered according to these numbers can be found below in the section of the specification entitled “References.” Each of these references is incorporated by reference herein.)

Directly modulated laser diodes exhibit positive chirp. This is due to the change of the refractive index in the laser cavity, which is caused by the slight change in the carrier density during modulation. The higher carrier density in the on-state causes a decrease of the refractive index due to the plasma effect. Thus, the modulation of the laser output power is connected with, in most cases, unwanted modulation of the laser wavelength.

Cleaved-coupled-cavity lasers have been investigated for the chirp dependence on device geometry and drive current [1]. Also, the linewidth characteristics for various current injection schemes to the two gain sections have been studied [2]. This previous work indicated that the spectral emission characteristics of laser diodes can be somewhat adjusted at the same time as the amplitude modulation of the optical signal. However, more than one element in the laser structure is needed to provide an additional degree of freedom in the laser drive conditions.

External modulators are known to exhibit less chirping when compared to directly modulated lasers in a similar application, because the change of the carrier density in the modulator waveguide is less pronounced. Electro-absorption modulators (EAM) exhibit chirp only during the transition period between the on-state and off-state and vice versa. This is due to the fact that the optical phase of the incoming lightwave is modified (extended or compressed) by the change of the refractive index of the modulator waveguide. The change of refractive index of the modulator waveguide is inherent to the change of the absorption coefficient in the modulator, which is employed to modulate the light intensity. According to the fundamental Kramers-Kronig Relation, every change in the imaginary part of the refractive index, which corresponds to the absorption coefficient, is connected to a change in the real part of the refractive index. The amount of change depends of the wavelength dependence of the material parameters which is a function of the applied bias field. Even the sign of change depends on wavelength. Thus, the real part of the refractive index can be larger or smaller under modulation of the waveguide absorption coefficient depending on wavelength and the applied bias.

This means that the chirp of the modulator can be adjusted by using the right amount of DC bias voltage. Preferably, a negative chirp is applied to compensate for the dispersion of the optical fiber. Adjusting the modulator to negative chirp implies a relatively high absorption in the modulator and also a low extinction ratio for the electrical signal [3]. These side effects are not desirable.

A small signal current modulation has been applied to distributed feedback (DFB) lasers to pre-distort the optical signal with respect to chirp [4]. The amplitude of the optical signal was modulated employing an external modulator device. The AC current for the laser was derived from the signal clock of the transmission data. The current into the laser causes the laser wavelength to change. If the phase of the laser current is chosen appropriately to the modulator voltage, a negative chirp figure can be obtained. Optical transmission experiments showed the benefit of the negative chirp on the signal regeneration after transmission through optical fiber that exhibit normal dispersion.

An external modulator has been described in conjunction with a directly modulated laser to compensate for signal distortion of the light output power [5]. The high speed electrical modulating signal is applied to the laser and the modulator section simultaneously. The non-linear transfer characteristics of the modulator cancels intermodulation distortion from the laser output. The modulation of the laser current encodes the data on the signal. This technique is described as being applied to analog optical distribution systems for cellular radio stations.

The publication in [6] describes a theoretical analysis of a DFB laser integrated with a two-section EAM. It is shown that the insertion loss can be minimized for a given overall chirp of the two-section modulator by applying the right bias voltage to either section. The length of the modulator is also optimized to achieve a certain extinction ratio.

Widely tunable lasers with an integrated semiconductor optical amplifier (SOA) and an integrated EAM have been published [7]. The patent applications of reference [8,9,10] describe such a device structure. In [8,9,10] also, a widely tunable laser with an integrated modulator consisting of two sections is described. No reference is made to the driving scheme of the two modulator sections, the relative lengths of the sections, or how to drive both sections to optimize chirp performance in the transmission system.

### SUMMARY OF THE INVENTION

The overall chirp of a multi-section laser transmitter employing an electro-absorption modulator (EAM) is adjusted by applying a chirp-compensating electrical signal to one of the laser sections. The amplitude of the optical signal is primarily generated by the modulator. The chirp is adjusted by the electrical signal applied to one of the laser sections. These sections can be (1) a forward-biased phase section inside the laser cavity, (2) a reverse-biased phase section inside the laser cavity, (3) a forward-biased section outside the laser cavity, or (4) a reverse-biased section outside the laser cavity.

### BRIEF DESCRIPTION OF THE DRAWINGS

FIG. 1 is a prior art schematic of a widely tunable sampled grating distributed Bragg reflector (SG-DBR) laser integrated with a semiconductor optical amplifier (SOA) and an electro-absorption modulator (EAM);

FIG. 2 is a schematic of a widely tunable SG-DBR laser with integrated SOA, EAM, and phase modulator sections;

FIGS. 3A-F are schematics of various chirp compensation embodiments; and

FIG.4 is a block diagram of an electrical control circuit to counteract chirp generated by modulator section.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

The present invention describes methods of chirp compensation in an integrated multi-section laser structure with an integrated modulator section by applying one or more compensating electrical signals to one or more electrodes inside or outside the laser cavity. The optical output power of the integrated laser transmitter is basically controlled by the change of the absorption of the integrated modulator section. The basic device structure is also known as an electro-absorption modulator laser (EML). The amplitude modulation in the modulator section causes a parasitic chirp effect during the transition period of the optical signal.

The differences between the present invention and the prior art include the following:

The present invention comprises a multi-section laser with an integrated modulator.

In the present invention, chirp compensation occurs by applying:

voltage to reverse-bias sections, or

current to forward-bias sections inside or outside the laser cavity.

Inside the laser cavity of the present invention, a change of frequency is accomplished using the following elements:

Phase modulator (reverse or zero bias),

Gain section (limited by relax frequency),

Phase section (saturable, short carrier lifetime), and

An optional high pass filter for creating phase changes.

Outside the laser cavity of the present invention, a change of phase is accomplished using the following element:

Pre-EAM section (reverse or zero bias), different bias, length, composition compared to post-EAM for ER (extinction ratio).

In the present invention, the compensating electrical signal comprises inverted data with some optional filtering and attenuation.

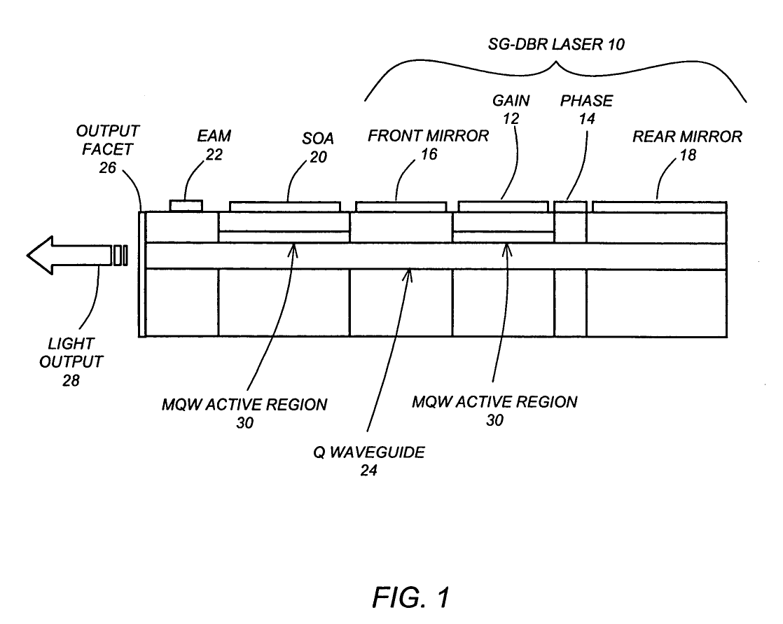

FIG. 1 illustrates an opto-electronic device comprising a widely tunable sampled grating distributed Bragg reflector (SG-DBR) laser 10. Publication [7] is a more advanced example of the prior art in basic laser transmitter structures. A laser cavity is comprised of a gain section 12, a phase section 14, and two SG-DBR sections 16, 18, i.e., a front mirror 16 and a rear mirror 18. The Bragg reflectors 16, 18 provide optical feedback for the laser 10, whereas the gain section 12 generates the photons for lasing action. The phase section 14 adjusts the optical path length between the mirrors 16, 18.

An SG-DBR laser 10 exhibits a comb-like spectrum of reflectivity peaks. The wavelength spacing of the Bragg reflector 16, 18 peaks is determined by the pitch of the grating bursts of the SG-DBR laser. Since the front and the back mirrors 16, 18 exhibit a slightly different pitch, the reflectivity peaks are aligned only for one wavelength in several periods. The distance to the next wavelength where they are aligned again is called the repeat mode spacing.

Wavelength tuning is achieved by current injection into the waveguide of the mirror sections 16, 18. The refractive index decreases due to the injected carriers and the reflectivity peaks shift towards to shorter wavelength side of the spectrum. The wavelength where the front and back mirror 16, 18 peaks are aligned jumps to a new wavelength. This is known as the Vernier effect and provides the wide tuning range of over 40 nanometers (nm). One mirror 16, 18 by itself moves approximately 8 nm maximum. If both mirrors 16, 18 are moved simultaneously, a fine tuning of the lasing wavelength can be achieved. The optical length of the phase section 14 is adjusted to fit a laser cavity mode between the two mirror sections 16, 18. The adjustment of a specific wavelength requires the control of all four currents for the front and back mirrors 16, 18, the phase section 14, and the gain section 12. The current for the gain section 14 generates the output power as well.

A semiconductor optical amplifier (SOA) section 20 and electro-absorption modulator (EAM) section 22 are added at the front of the SG-DBR laser 10. The tuning sections 12, 14, 16 and 18 of the laser 10 use the same bulk quaternary (Q) waveguide 24 as the active region of the EAM 22, wherein the waveguide 24 is curved and an output facet 26 is anti-reflection coated to prevent parasitic reflections. The EAM 22 is based on the Franz-Keldysh effect, thereby enabling high speed operation. The bandgap, doping, and thickness of the bulk Q waveguide 24 are optimized for high tuning efficiency for the laser 10 and a target extinction ratio for the EAM 22. The integrated SOA 20 controls the average output power of the light output 28 from the laser 10, and the EAM 22 provides high speed signal modulation of the light output 28. Both the SOA 20 and gain section 12 include multi-quantum-well (MQW) active regions 30.

Amplitude modulation causes a transient wavelength shift of the light output 28 from the laser 10 during a transition period between an on-state and an off-state of the laser 10. This is referred to as a transient chirp. Residual back reflections from the output facet 26 can also cause a wavelength shift of the light output 28 due to an optical feedback effect. This wavelength shift occurs during the whole on-state of the EAM 22 is called adiabatic chirp.

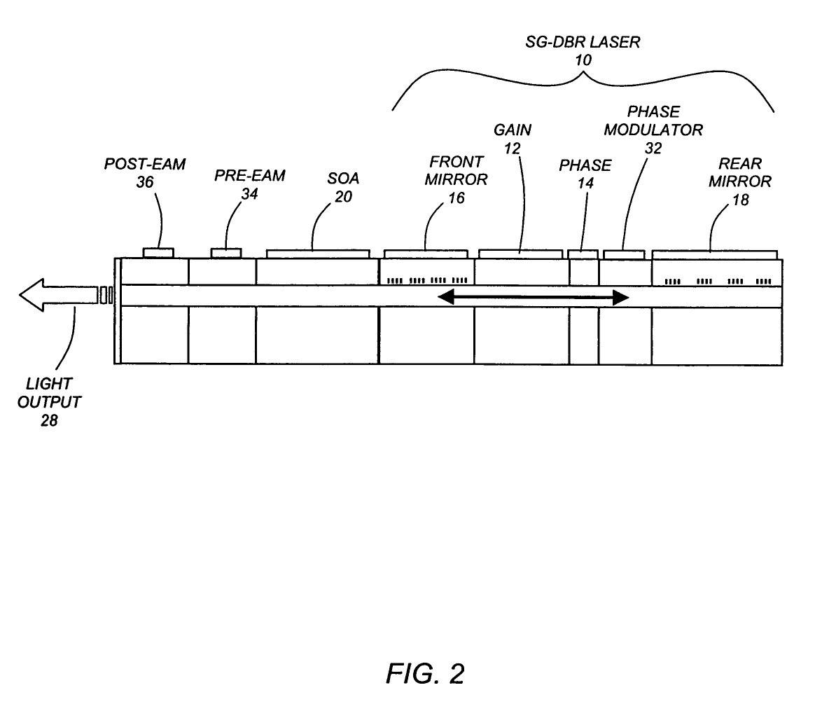

FIG. 2 illustrates how the chirp of the laser 10 is compensated by applying an electrical signal to one or more of the sections of the laser 10. These sections can be: (1) a forward-biased gain section 12 inside the laser cavity, (2) a forward-biased phase section 12 inside the laser cavity, (3) a reverse-biased phase modulator section 32 inside the laser cavity, (4) a forward-biased SOA section 20 outside the laser cavity, or (5) a reverse-biased pre-EAM section 34 or post-EAM section 36 outside the laser cavity.

In general, refractive index changes of any section 12, 14, 16, 18, 32 inside the laser cavity yield to a change of wavelength of the light output 28. A change of the refractive index of a section 20, 34, 36 outside the laser cavity results in a phase change of the light output 28. The chirp compensating electrical signal to one of the laser sections 12, 14, 16, 18 is adjusted in amplitude and phase relative to the electrical modulation signal driving the modulator sections 32, 34, 36 of the laser 10. The amplitude and phase adjustment is chosen for optimum chirp in the laser 10.

If the compensating electrical signal is applied to one of the sections 12, 14, 16, 18, 32 inside the laser cavity, then an additional electrical differentiator element, such as a high pass filter, might be employed. This element would transform the induced wavelength change into a phase change of the light output 28 compensating for transient chirp.

However, the right setting of bias points for the electrical signal can also be used to compensate for transient chirp. In this case, the wavelength during the off-state of the modulator 32, 34, 36 might have any value. Since the light output 28 amplitude is minimum, the wavelength is not transmitted by the device.

Not all the sections of the laser 10 shown in FIG. 2 are necessarily integrated in the actual device. Sections not required for chirp compensation or laser performance may not be not realized, thereby simplifying the device design and manufacturing.

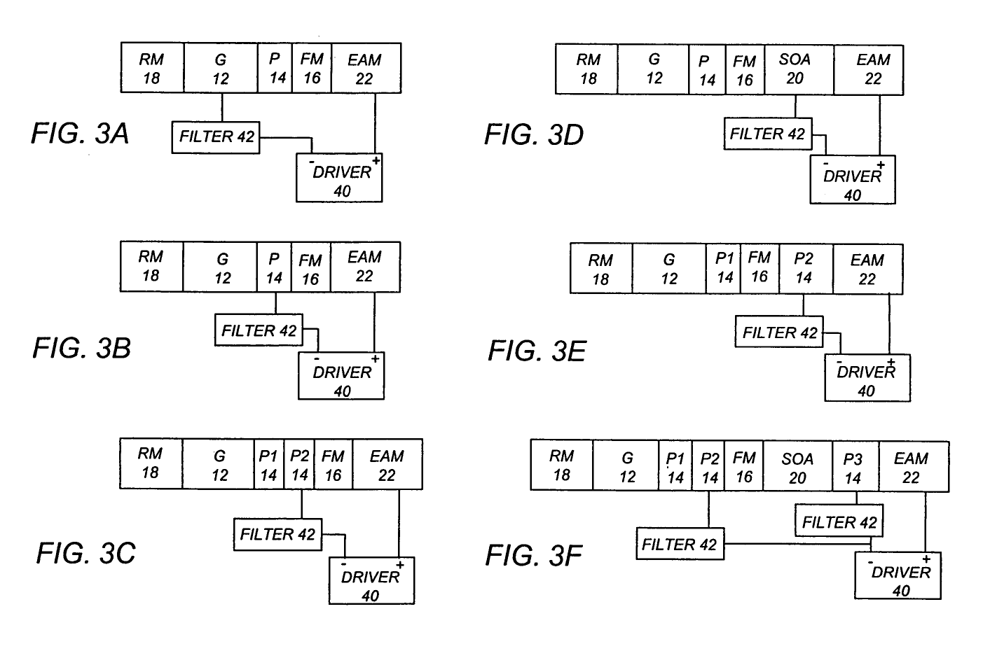

FIGS. 3A-F describe embodiments of an electrical circuit for chirp compensation employing the various sections of the laser 10, including the gain (G) section 12, phase (P, P1, P2) sections 14, front mirror (FM) section 16, rear mirror (RM) section 18, semiconductor optical amplifier (SOA) section 20 and electro-absorption modulator (EAM) section 22. Generally, the electrical circuit includes both a driver 40 and one or more filters 42.

Referring to FIG. 3A, the gain (G) section 12 of the tunable laser generates the optical output at a specific wavelength. A modulator chirp compensating electrical signal can be applied to the gain section 12 to change the wavelength of the optical output during a transition period between an optical on-state and an off-state of the EAM 22. Since the compensating electrical signal is applied to the gain section 12, the speed is not limited by carrier life time, but by the small signal frequency response of the laser. This is typically in the range of many gigahertz (GHz).

During an optical 1 of the EAM 22, the current to the gain section 12 is reduced; during the optical 0 of the EAM 22, the current to the gain section 12 is increased. The modulation of the current to the gain section 12 is opposite to the normal laser operation under direct modulation. The carrier density varies, which causes a wavelength shift as described above. This wavelength shift over-compensates the chirp of the EAM 22. As described above, the laser chirp is normally much larger than the contribution of an EAM 22. Thus, the chirp of the EAM 22 can be adjusted by adjusting the current through the gain section 12.

In a variation from the chirp compensation procedure described above, the gain section 12 current can also be changed during the transition period of the EAM 22 only. Or, the gain section 12 current is changed during the entire on-state and off-state, respectively, but a peak is applied to the current change during the transition period. This could be accomplished by differentiating the electrical signal, or a more complicated control scheme might be employed for improved wavelength control.

Referring to FIG. 3B, a chirp counteracting electrical signal might be applied to the phase (P) section 14 of the widely tunable SG-DBR laser. The phase section 14 is already employed for wavelength fine tuning under normal operating conditions. Thus, a small change in the phase section 14 current can provide a significant wavelength change to compensate for chirp. However, the disadvantage of this approach is that the carrier density of the phase section 14 can only be changed with a time constant which is given by the carrier life time. Typical values for this life time are in the range of a few nanoseconds, unless this section 14 is heavily forward biased. Thus, the maximum speed where this compensation can be applied is limited to a few hundred megahertz (MHz), unless it is always kept in strong forward bias over its operating range for wavelength tuning.

Referring to FIG. 3C, a chirp compensating electrical signal can be applied to an additional reverse or zero biased phase section (P2) 14 inside the laser cavity. A negative voltage changes the absorption and the refractive index of the waveguide material. For phase modulation, the amount of absorption increase should be minimized. This is accomplished by the right choice of composition of the material with an absorption edge far enough from the laser wavelength. The amount of DC bias voltage also controls how much the absorption and the refractive index changes under RF modulation. Since the wavelength difference of the absorption edge relative to the laser light changes in a tunable laser, the bias voltage can be used to adjust the wavelength offset accordingly. The speed of this compensation scheme is limited by the life time of the photons inside the laser cavity. As for the gain section 12, this typically corresponds to several GHz.

Referring to FIG. 3D, a chirp compensating electrical signal can be applied to a forward-biased section outside the laser cavity, such as the SOA section 20. The change of drive current to the SOA 20 is connected with an undesirable change of the optical output power. During the optical 1 of the EAM 22, the current to the SOA 20 is reduced; during the optical 0 of the EAM 22, the SOA 20 current is increased. The modulation of the SOA 20 current is opposite to the EAM 22 operation. The carrier density varies, which causes a phase shift of the laser light passing through. This phase shift can compensate or even over-compensate the chirp of the EAM 22. The speed of the carrier density is limited by the carrier life time. Since the SOA section 20 is driven at high injection levels, the life time is relatively short and the inherent speed can exceed a gigahertz. With suitable filtering of the chirp compensating electrical signal to compensate the frequency roll-off, useful chirp compensation can be achieved up to 10 gigabits per second (Gbit/s).

Referring to FIG. 3E, a chirp compensating electrical signal can be applied to a zero or reverse biased-section outside the laser cavity, such as a phase pre-modulator (P2) section 14. This phase pre-modulator section 14 provides a phase shift that is opposite to the chirp of the post-EAM 22. The negative voltage applied to the phase pre-modulator section 14 changes the absorption and the refractive index of the waveguide material. For the desired phase modulation, the amount of absorption increase should be minimized. This is accomplished by the right choice of composition of the material with an absorption edge far enough from the laser wavelength and a small or zero DC bias that gives predominately phase changes rather than amplitude changes. The amount of DC bias voltage also controls the how much the absorption and the refractive index changes under RF modulation. Since the wavelength difference of the absorption edge relative to the laser light changes in a tunable laser, the bias voltage can be used to adjust the wavelength offset accordingly. The speed of this compensation scheme is consistent with the amplitude modulator. The modulation speed is limited by the parasitic RC time constant of the modulator. Many GHz can be achieved.

The length of the pre- and post-modulator sections need to be optimized for extinction ratio, RF amplitude, DC bias voltage, and chirp. Since the pre-modulator should primarily change the refractive index of the material, the bias voltage should be lower than for the post-modulator where a large change in the absorption is desired. At the modulator operating point where the absorption change is high, the refractive index change is also relatively large. Thus, to compensate for the change, the pre-modulator section with the smaller index change should be longer to exhibit the same amount of phase shift in the opposite direction. Also, it is desirable for the pre-modulator to be more than twice as long as the EAM and its drive voltage to be proportionally smaller to avoid reduction in on-state transmission if the same bandgap material is used for both.

A further optimization of the chirp adjustment could be accomplished by modifying the bandgap energy offset of the two modulator sections. The bandgap energy of the pre-modulator section can be increased by methods like quantum well intermixing [11,12]. This leaves a larger difference between the absorption edge and the laser wavelength. The amount of absorption under reverse bias is reduced and a larger voltage can be applied to the phase section without resulting in a reduction in the on-state transmission.

Referring to FIG. 3F, a chirp compensating electrical signal can also be applied to multiple sections of the laser combining the various schemes discussed above. FIG. 3F gives an example showing the chirp compensating electrical signal being applied to the zero- or reverse-biased phase (P2) section 14 outside the laser cavity and to the zero- or reverse-biased phase (P3) section 14 inside the laser cavity. The section 14 outside the laser cavity compensates for the transient chirp of the modulator. The additional phase section 14 inside the laser cavity predominantly compensates for any adiabatic chirp. The feedback to more than one section provides another degree of freedom in optimizing the laser performance for transmission systems.

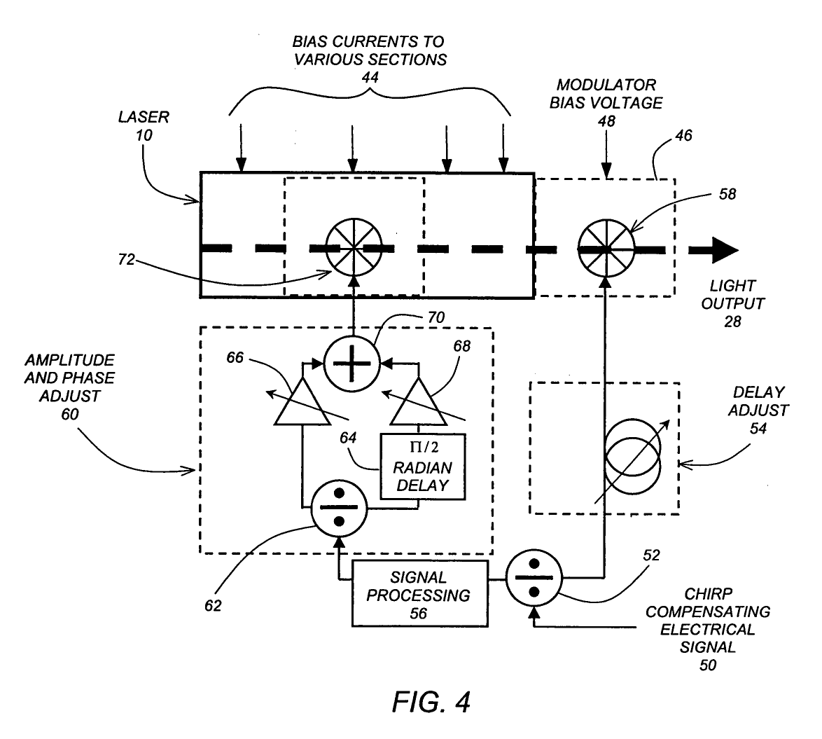

FIG. 4 illustrates a possible electrical control circuit used for chirp compensation. As noted above, each of the various sections of the laser 10 are driven by various bias currents 44, except for the zero- or reverse-biased sections 46, which are driven by an additional bias voltage 48.

A chirp compensating electrical signal 50 is applied to one or more of the sections of the laser 10 inside or outside the laser cavity according to the discussion above. The amplitude and/or phase adjustment of the chirp compensating electrical signal 50 applied to the sections of the laser is arbitrarily shown as a vector modulator.

The chirp compensating electrical signal 50 is coupled to a connector 52, which then splits the signal to a delay adjust 54 and a (differentiating) signal processing block 56 that performs high pass filtering.

The delay adjust 48 is arbitrarily shown as a variable delay. However, once the desired delay is known, the delay adjust 48 could be fixed. The output of the delay adjust 54 is provided to the zero- or reversed-bias section 46 to provide modulator chirp generation 58.

The signal processing block 56 high pass filters the chirp compensating electrical signal 50 to enhance certain frequency characteristics and to compensate for transient chirp. The output of the signal processing block 56 is then provided to an amplitude and phase adjust 60.

In the amplitude and phase adjust 60, a connector 62 splits the signal to a II/2 radian delay 64 and a variable amplifier 66. The output from the II/2 radian delay 64 is also provided to a variable amplifier 68. The outputs from both variable amplifiers 66,68 are combined at 70, and then provided to the selected section of the laser to provide a counteracting chirp generation 72.

A much simpler, possibly fixed, circuit could be employed in place of the amplitude and phase adjust 60, once the desired amplitude and phase relationships are determined. The compensation signal amplitude, phase, and delay could also be optimized according to the laser wavelength with individual settings for each channel.

In addition, the amplitude and phase adjust 60, as well as the delay adjust 54, could be controlled based on chirp or impairment monitoring at an output of the laser 10, or elsewhere in a system using the laser 10 (e.g., at an end-of-line optical receiver). In such an embodiment, the amplitude and phase adjust 60 and the delay adjust 54 would include an initial set of parameter values that are then adaptively changed according to the monitoring. These parameter values might also be chosen to be channel specific.

Moreover, in another embodiment, the compensating electrical signal can be used to generate a light output 28 from the laser 10 with negative pre-chirp in order to compensate for positive chirp in an optical transmission line (not shown). The amplitude of the negative pre-chirp could be adjusted according to the amount of dispersion of the optical transmission line. The adjustment of the amplitude of the negative pre-chirp could even be dynamic to compensate for drift over time. Such a scheme would be beneficial for systems operating at very high speed, e.g., 40 Gbit/s and beyond, where small changes in dispersion already have a large impact on the system transmission performance.

### References

The following references are incorporated by reference herein:

[1] L. A. Coldren, G. D. Boyd, and C. A. Burrus, “Dependence of chirping on cavity separation in two-section coupled-cavity lasers,” Electron. Lett., vol. 21, pp. 527-528, 1985.

[2] L. A. Coldren, G. D. Boyd, J. E. Bowers, and C. A. Burrus, “Reduced dynamic linewidth in three-terminal two-section diode lasers,” Appl. Phys. Lett., vol. 46, pp. 125-127, 1984.

[3] Lucent/Agere Application Note TN00008 on electro-absorption modulators (EML), May 2000.

[4] N. Henmi, T. Saito, and T. Ishida, “Prechirp technique as a linear dispersion compensation for ultrahigh-speed long-span intensity modulation directed detection optical communication systems,” J. of Lightwave Technology, vol. 12, pp. 1706-1719, 1994.

[5] U.S. Pat. No. 6,320,688 B1, issued Nov. 20, 2001, to Leslie D. Westbrook and David G. Moodie, and entitled “Optical Transmitter.”

[6] M. Claassen, W. Harth, and B. Stegmueller, “Two-section electroabsorption modulator with negative chirp at low insertion loss,” Electronics Lett., vol. 32, pp. 2121-2122, 1996.

[7] T. Wipiejewski, Y. A. Akulova, C. Schow, A. Karim, S. Nakagawa, P. Kozodoy, G. Fish, J. DeFranco, A. Dahl, M. Larson, D. Pavinski, T. Butrie, and L. A. Coldren, “Monolithic Integration of a Widely Tunable Laser Diode with a High Speed Electro Absorption Modulator,” 52^{nd} ECTC, San Diego, May 2002.

[8] U.S. patent application Ser. No. 09/614,378, filed Jul. 12, 2000, by Gregory A. Fish and Larry A. Coldren, entitled “Opto-Electronic Laser with Integrated Modulator.”

[9] U.S. patent application Ser. No. 09/614,376, filed Jul. 12, 2000, by Gregory A. Fish and Larry A. Coldren, entitled “Method of Modulating an Optical Wavelength with an Opto-electronic Laser with Integrated Modulator.”

[10] U.S. patent application Ser. No. 09/614,195, filed Jul. 12, 2000, by Gregory A. Fish and Larry A. Coldren, entitled “Method of Making an Opto-electronic Laser with Integrated Modulator.”

[11] S. Charbonneau, E. Kotels, P. Poole, J. He, G. Aers, J. Haysom, M. Buchanan, Y. Feng, A. Delage, F. Yang, M. Davies, R. Goldberg, P. Piva, and I. Mitchell, “Photonic Integrated Circuits Fabricated Using Ion Implantation,” IEEE J. Sel. Topics in Quantum Electron., vol. 4, pp. 772-793, 1998.

[12] E. Skogen, J. Barton, S. DenBaars, and L. Coldren, “Tunable Buried Ridge Stripe Sampled Grating Distributed Bragg Reflector Lasers Utilizing Quantum Well Intermixing,” presented at the IEEE LEOS annual meeting, San Diego, Calif., 2001.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. An opto-electronic device, comprising:
a multiple-section laser;
a modulator section monolithically-integrated with the laser; and
a circuit for adjusting a chirp of the opto-electronic device by applying a compensating electrical signal to one or more sections of the laser, wherein modulation of the laser by the modulator section causes a parasitic chirp effect and the compensating electrical signal is applied to another one of the sections of the laser to change a wavelength of the laser's output between and/or during a transition period between an optical on-state and an optical off-state of the modulator section of the laser.

2. The device of claim 1, wherein the laser is a widely-tunable laser.

3. The device of claim 1, wherein the modulator section comprises an electro-absorption modulator.

4. The device of claim 1, wherein the compensating electrical signal comprises data applied to the modulator section is inverted in sign and filtered to suitably emphasize leading and trailing edges of transitions in the data.

5. The device of claim 1, wherein amplitude adjustments are made to the compensating electrical signal.

6. The device of claim 1, wherein phase adjustments are made to the compensating electrical signal.

7. The device of claim 1, wherein delay adjustments are made to the modulator section signal.

8. The device of claim 1, wherein delay adjustments are made to the compensating electrical signal.

9. The device of claim 1, wherein the compensating electrical signal is optimized according to an emission wavelength of the laser's output in terms of amplitude, phase, electrical delay adjustment.

10. The device of claim 1, wherein the compensating electrical signal is derived from a calibration performed to optimize amplitude, phase, and electrical delay adjustment of the circuit.

11. The device of claim 10, wherein the compensating electrical signal is changed over time to compensate for fluctuations in characteristics of the laser.

12. The device of claim 1, wherein the compensating electrical signal is applied to a gain section of the laser to change a wavelength of the laser's output during the transition period between the optical on-state and the optical off-state of the laser.

13. The device of claim 12, wherein the compensating electrical signal is applied to the gain section of the laser during the transition period between the optical on-state and the optical off-state of the laser to change a wavelength of the laser's output during the transition period, thereby resulting in a phase shift of the laser's output.

14. The device of claim 1, wherein the compensating electrical signal is applied to a forward biased phase section of the laser inside the laser's cavity to change a wavelength of the laser's output during the transition period between the optical on-state and the optical off-state of the laser.

15. The device of claim 14, wherein the compensating electrical signal is applied to a forward biased phase section of the laser inside the laser's cavity during the transition period between the optical on-state and the optical off-state of the laser to change a wavelength of the laser's output during the transition period, thereby resulting in a phase shift of the laser's output.

16. The device of claim 1, wherein the compensating electrical signal is applied to a reverse or zero biased phase section of the laser inside the laser's cavity to change a wavelength of the laser's output during the transition period between the optical on-state and the optical off-state of the laser.

17. The device of claim 16, wherein the compensating electrical signal is applied to the reverse or zero biased phase section of the laser inside the laser's cavity during the transition period between the optical on-state and the optical off-state of the laser to change a wavelength of the laser's output during the transition period, thereby resulting in a phase shift of the laser's output.

18. The device of claim 1, wherein the compensating electrical signal is applied to a forward biased phase section of the laser outside the laser's cavity to change a wavelength of the laser's output during the transition period between the optical on-state and the optical off-state of the laser.

19. The device of claim 1, wherein the compensating electrical signal is applied to a reverse biased phase section of the laser outside the laser's cavity to change a wavelength of the laser's output during the transition period between the optical on-state and the optical off-state of the laser.

20. An apparatus for chirp control of an integrated laser-modulator having multiple sections, comprising:
a circuit for adjusting a chirp of a laser by applying a compensating electrical signal to one or more sections of the laser, wherein modulation of the laser by a modulator section causes a parasitic chirp effect and the compensating electrical signal is applied to another one of the sections of the laser to change a wavelength of the laser's output between and/or during a transition period between an optical on-state and an optical off-state of the modulator section of the laser.

21. The apparatus of claim 20, wherein the laser is a widely-tunable laser.

22. The apparatus of claim 20, wherein the modulator section comprises an electro-absorption modulator.

23. The apparatus of claim 20, wherein the compensating electrical signal comprises data applied to the modulator section is inverted in sign and filtered to suitably emphasize leading and trailing edges of transitions in the data.

24. The apparatus of claim 20, wherein amplitude adjustments are made to the compensating electrical signal.

25. The apparatus of claim 20, wherein phase adjustments are made to the compensating electrical signal.

26. The apparatus of claim 20, wherein delay adjustments are made to the modulator section signal.

27. The apparatus of claim 20, wherein delay adjustments are made to the compensating electrical signal.

28. The apparatus of claim 20, wherein the compensating electrical signal is optimized according to an emission wavelength of the laser's output in terms of amplitude, phase, electrical delay adjustment.

29. The apparatus of claim 20, wherein the compensating electrical signal is derived from a calibration performed to optimize amplitude, phase, and electrical delay adjustment of the circuit.

30. The apparatus of claim 29, wherein the compensating electrical signal is changed over time to compensate for fluctuations in characteristics of the laser.

31. The apparatus of claim 20, wherein the compensating electrical signal is applied to a gain section of the laser to change a wavelength of the laser's output during the transition period between the optical on-state and the optical off-state of the laser.

32. The apparatus of claim 31, wherein the compensating electrical signal is applied to the gain section of the laser during the transition period between the optical on-state and the optical off-state of the laser to change a wavelength of the laser's output during the transition period, thereby resulting in a phase shift of the laser's output.

33. The apparatus of claim 20, wherein the compensating electrical signal is applied to a forward biased phase section of the laser inside the laser's cavity to change a wavelength of the laser's output during the transition period between the optical on-state and the optical off-state of the laser.

34. The apparatus of claim 33, wherein the compensating electrical signal is applied to a forward biased phase section of the laser inside the laser's cavity during the transition period between the optical on-state and the optical off-state of the laser to change a wavelength of the laser's output during the transition period, thereby resulting in a phase shift of the laser's output.

35. The apparatus of claim 20, wherein the compensating electrical signal is applied to a reverse or zero biased phase section of the laser inside the laser's cavity to change a wavelength of the laser's output during the transition period between the optical on-state and the optical off-state of the laser.

36. The apparatus of claim 35, wherein the compensating electrical signal is applied to the reverse or zero biased phase section of the laser inside the laser's cavity during the transition period between the optical on-state and the optical off-state of the laser to change a wavelength of the laser's output during the transition period, thereby resulting in a phase shift of the laser's output.

37. The apparatus of claim 20, wherein the compensating electrical signal is applied to a forward biased phase section of the laser outside the laser's cavity to change a wavelength of the laser's output during the transition period between the optical on-state and the optical off-state of the laser.

38. The apparatus of claim 20, wherein the compensating electrical signal is applied to a reverse biased phase section of the laser outside the laser's cavity to change a wavelength of the laser's output during the transition period between the optical on-state and the optical off-state of the laser.

39. A method of chirp control of an integrated laser-modulator having multiple sections, comprising:
adjusting a chirp of a laser by applying a compensating electrical signal to one or more sections of the laser, wherein modulation of the laser by a modulator section causes a parasitic chirp effect and the compensating electrical signal is applied to another one of the sections of the laser to change a wavelength of the laser's output between and/or during a transition period between an optical on-state and an optical off-state of the modulator section of the laser.

40. The method of claim 39, wherein the laser is a widely-tunable laser.

41. The method of claim 39, wherein the modulator section comprises an electro-absorption modulator.

42. The method of claim 39, wherein the compensating electrical signal comprises data applied to the modulator section is inverted in sign and filtered to suitably emphasize leading and trailing edges of transitions in the data.

43. The method of claim 39, wherein amplitude adjustments are made to the compensating electrical signal.

44. The method of claim 39, wherein phase adjustments are made to the compensating electrical signal.

45. The method of claim 39, wherein delay adjustments are made to the modulator section signal.

46. The method of claim 39, wherein delay adjustments are made to the compensating electrical signal.

47. The method of claim 39, wherein the compensating electrical signal is optimized according to an emission wavelength of the laser's output in terms of amplitude, phase, electrical delay adjustment.

48. The method of claim 39, wherein the compensating electrical signal is derived from a calibration performed to optimize amplitude, phase, and electrical delay adjustment of the circuit.

49. The method of claim 48, wherein the compensating electrical signal is changed over time to compensate for fluctuations in characteristics of the laser.

50. The method of claim 39, wherein the compensating electrical signal is applied to a gain section of the laser to change a wavelength of the laser's output during the transition period between the optical on-state and the optical off-state of the laser.

51. The method of claim 50, wherein the compensating electrical signal is applied to the gain section of the laser during the transition period between the optical on-state and the optical off-state of the laser to change a wavelength of the laser's output during the transition period, thereby resulting in a phase shift of the laser's output.

52. The method of claim 39, wherein the compensating electrical signal is applied to a forward biased phase section of the laser inside the laser's cavity to change a wavelength of the laser's output during the transition period between the optical on-state and the optical off-state of the laser.

53. The method of claim 52, wherein the compensating electrical signal is applied to a forward biased phase section of the laser inside the laser's cavity during the transition period between the optical on-state and the optical off-state of the laser to change a wavelength of the laser's output during the transition period, thereby resulting in a phase shift of the laser's output.

54. The method of claim 39, wherein the compensating electrical signal is applied to a reverse or zero biased phase section of the laser inside the laser's cavity to change a wavelength of the laser's output during the transition period between the optical on-state and the optical off-state of the laser.

55. The method of claim 54, wherein the compensating electrical signal is applied to the reverse or zero biased phase section of the laser inside the laser's cavity during the transition period between the optical on-state and the optical off-state of the laser to change a wavelength of the laser's output during the transition period, thereby resulting in a phase shift of the laser's output.

56. The method of claim 39, wherein the compensating electrical signal is applied to a forward biased phase section of the laser outside the laser's cavity to change a wavelength of the laser's output during the transition period between the optical on-state and the optical off-state of the laser.

57. The method of claim 39, wherein the compensating electrical signal is applied to a reverse biased phase section of the laser outside the laser's cavity to change a wavelength of the laser's output during the transition period between the optical on-state and the optical off-state of the laser.
